(19) United States
(12) Patent Application Publication
(10) Pub. No.: US 2008/0265781 A1
(43) Pub. Date: Oct. 30, 2008

(54) LIGHT SOURCE MODULE

(75) Inventors: Shin-Chang Lin, Taipei County (TW); Bi-Hsien Chen, Pingtung County (TW); Han-Yu Chao, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/840,989

(22) Filed: Aug. 19, 2007

(30) Foreign Application Priority Data
Apr. 26, 2007 (TW) 96114735

(51) Int. Cl. H01J 7/24; H05B 37/00

(52) U.S. Cl. 315/113; 315/325

(57) ABSTRACT

A light source module including a circuit substrate, light emitting chip packages, and driving devices is provided. The circuit substrate has a top surface and a bottom surface opposite to the top surface. The bottom surface has at least one component installed area and at least one metal exposed area. The light emitting chip packages are disposed on the top surface. The driving devices are disposed in the component installed area. The driving devices are electrically connected to the light emitting chip packages through the circuit substrate.

### CROSS-REFERENCE TO RELATED APPLICATION

This application claims the priority benefit of Taiwan application serial no. 96114735, filed Apr. 26, 2007. All disclosure of the Taiwan application is incorporated herein by reference.

### BACKGROUND OF THE INVENTION

1. Field of the Invention

The present invention relates to a light source module, and more particularly to a light source module adopting light emitting chip packages.

2. Description of Related Art

With progress in the technology, nowadays, the light emitting diode (LED) has the advantages of high luminance, low driving voltage and fast driving speed. Therefore, LEDs have already been adopted as the light source of the back light module in some liquid crystal displays (LCDs).

FIG. 1 is a schematic top view of a conventional back light module adopting an LED as its light source. Referring to FIG. 1, a back light module 100 includes an LED module board 110, a driver board 120 and a cable 130. The LED module board 110 includes a plurality of LEDs 112, a first connector 114 and a first printed circuit board (PCB) 116. The LEDs 112 and the first connector 114 are disposed on the first PCB 116. The first connector 114 is electrically connected with the LEDs 112 through the first PCB 116.

The driver board 120 includes a plurality of driving devices 122, a second connector 124 and a second PCB 126. The driving devices 122 and the second connector 124 are disposed on the second PCB 126. The second connector 124 is electrically connected with the driving devices 122 through the second PCB 126. The cable 130 is electrically connected between the first connector 114 and the second connector 124. Thus, the driver board 120 drives the LEDs 112 through the cable 130.

However, since the back light module 100 includes additional components such as the first PCB 116, the second PCB 126, the first connector 114, the second connector 124 and the cable 130, not only the manufacturing cost of the back light module 100 is increased, but also the assembling process is rendered overly complicated such that the assembling time is prolonged.

### SUMMARY OF THE INVENTION

The present invention is directed to a light source module with the characteristics of a low manufacturing cost and short assembling time.

As embodied and broadly described herein, the invention is directed to a light source module including a circuit substrate, a plurality of light emitting chip packages and a plurality of driving devices. The circuit substrate has a top surface and a bottom surface opposite thereto. The bottom surface has at least one component installed area and at least one metal exposed area. The light emitting chip packages are disposed on the top surface. The driving devices are disposed in the component installed area. The driving devices are electrically connected to the light emitting chip packages through the circuit substrate.

According to one embodiment of the invention, the circuit substrate may further include a solder mask. The solder mask is disposed in the component installed area and exposes the metal exposed area.

According to one embodiment of the invention, the metal exposed area may be a copper exposed area or an aluminum exposed area.

In one embodiment of the invention, the component installed area and the metal exposed area may be alternately arranged.

In one embodiment of the invention, the light emitting chip packages include light emitting diode (LED) packages or organic light emitting diode (OLED) packages.

In one embodiment of the invention, the light source module further includes a heat sink, a thermal grease or a heat pipe disposed in the metal exposed area.

In view of the aforementioned, the plurality of driving devices and the plurality of light emitting chip packages are assembled on the same circuit substrate in the light source module of the invention, so that the number of components in the light source module is reduced so as to lower the manufacturing cost. Meanwhile, the assembling process of the light source module in the invention is simplified so as to shorten the assembling time as well.

In order to the make the aforementioned and other objects, features and advantages of the present invention more comprehensible, preferred embodiments accompanied with figures are described in detail below.

### BRIEF DESCRIPTION OF THE DRAWINGS

FIG. 1 is a schematic top view of a conventional back light module adopting LEDs as a light source.

FIG. 2A is a schematic bottom view of the light source module according to the first embodiment of the present invention.

FIG. 2B is a schematic side view of the light source module of FIG. 2A along the direction A.

FIG. 3 is a schematic bottom view of the light source module according to the second embodiment of the invention.

FIG. 4 is a schematic bottom view of a back light module adopting the light source module of the invention.

FIG. 5 is a schematic bottom view of another back light module adopting the light source module of the invention.

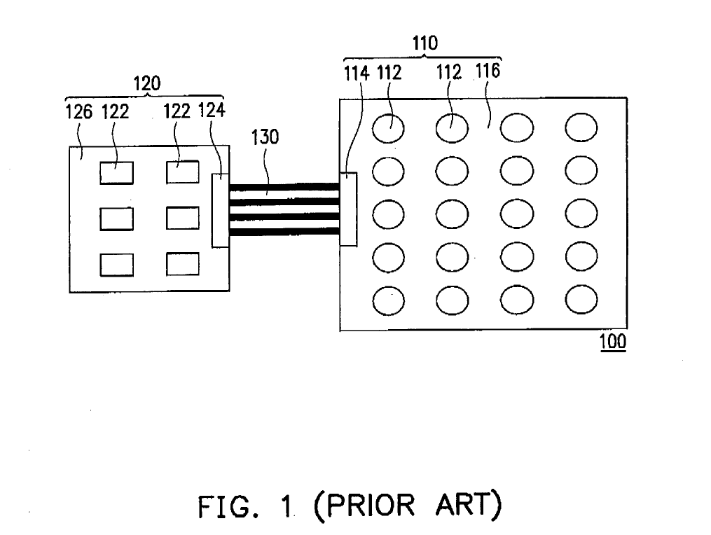

### DESCRIPTION OF EMBODIMENTS

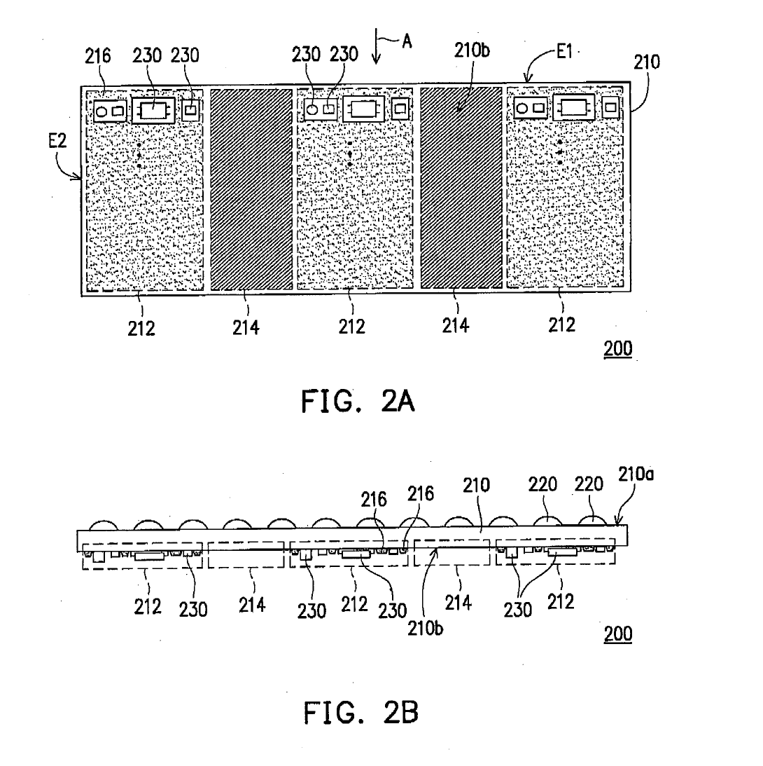

FIG. 2A is a schematic bottom view of the light source module according to the first embodiment of the present invention. FIG. 2B is a schematic side view of the light source module of FIG. 2A along a direction A. Referring to FIGS. 2A and 2B, a light source module 200 includes a circuit substrate 210, a plurality of light emitting chip packages 220 and a plurality of driving devices 230. The light source module 200 can be used as a back light module in a display or a light source module for other lighting purposes.

The circuit substrate 210 has a top surface 210a and a bottom surface 210b. The bottom surface 210b is opposite to the top surface 210a. The bottom surface 210b has at least one component installed area 212 and at least one metal exposed area 214. Although the circuit substrate 210 illustrated in FIG. 2A has three component installed areas 212 and two metal exposed areas 214, the numbers of the component installed areas 212 and the metal exposed areas 214 only serve as examples to facilitate illustration and are not intended to limit the invention.

The plurality of light emitting chip packages 220 are disposed on the top surface 210a. The light emitting chip packages 220 may be light emitting diode (LED) packages, organic light emitting diode (OLED) packages or other suitable light emitting components. The plurality of driving devices 230 are disposed only in the component installed area 212 and not in the metal exposed area 214. The circuit substrate 210 is, for example, a multi-layer circuit board, a double-sided circuit board, an HDI circuit board, a metal core circuit board or other suitable circuit boards. Hence, the driving devices 230 can be electrically connected with the light emitting chip packages 220 through the circuit substrate 210 so as to drive the light emitting chip packages 220 to emit light.

The metal exposed area 214 may be a copper exposed areas or an aluminum exposed area. The function of the metal exposed area 214 is to facilitate dissipation of the heat generated by the light emitting chip packages 220 and the driving devices 230 to the surrounding environment so as to achieve even dissipation of the heat. According to the present embodiment, in order to improve the dissipation efficiency of the metal exposed area 214, the light source module 200 may further include a heat sink, a thermal grease, a heat pipe or other dissipation devices disposed in the metal exposed area 214. Certainly, even if the foregoing dissipation devices are not disposed in the metal exposed area 214, the metal exposed area 214 can still dissipate heat evenly.

The circuit substrate 210 may further include a solder mask 216 (illustrated as dots irregularly distributed in FIGS. 2A and 2B). The solder mask 216 is disposed only in the component installed area 212 and exposes the metal exposed area 214. The material of the solder mask 216 may be a polymer material. Since the solder mask 216 is not disposed in the metal exposed area 214, the metal exposed area 214 can still help the light source module 200 dissipate heat evenly. Furthermore, the overall performance of the light source module 200 of the invention is not affected whether the solder mask 216 exists or not. Therefore, the solder mask 216 illustrated in FIGS. 2A and 2B only serve as examples to facilitate illustration and is not intended to limit the invention.

According to the present embodiment, there may be a plurality of component installed areas 212 and a plurality of metal exposed areas 214 on the bottom surface 210b, and the component installed areas 212 and the metal exposed areas 214 may be alternately arranged. Referring to FIG. 2A, the plurality of component installed areas 212 and the plurality of metal exposed areas 214 may be alternately disposed along a long edge E1 of the bottom surface 210b. Each of the component installed areas 212 and the metal exposed areas 214 may extend along a short edge E2 of the bottom surface 210b, as illustrated in FIG. 2A.

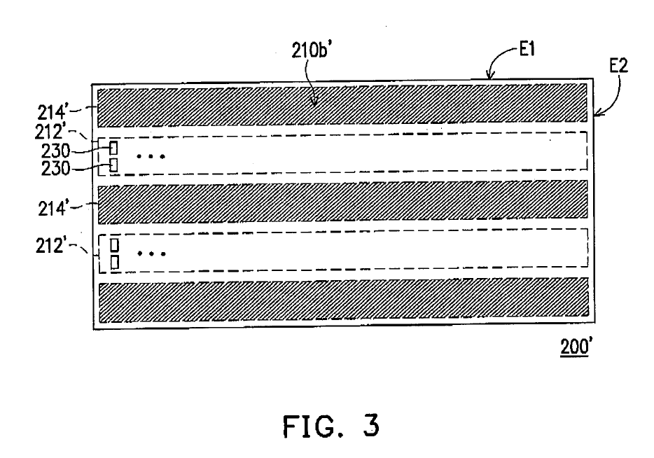

FIG. 3 is a schematic bottom view of the light source module according to the second embodiment of the invention. Referring to FIG. 3, a light source module 200′ of the second embodiment is similar to the light source module of the first embodiment. Nevertheless, the difference between the first and the second embodiments lies in the arrangement of the component installed areas 212′ and metal exposed areas 214′ in the light source module 200′. In more detail, the component installed areas 212′ and the metal exposed areas 214′ may be alternately arranged along a short edge E2 of a bottom surface 210b′. Each of the component installed areas 212′ and each of the metal exposed areas 214′ extends along a long edge E1 of the bottom surface 210b′.

Although the component installed areas and the metal exposed areas of the invention are arranged as those described in the foregoing embodiments, the ways the component installed areas and the metal exposed areas are arranged in FIGS. 2A and 3 only serve as examples to facilitate illustration. It is emphasized that the arrangements are not intended to limit the invention.

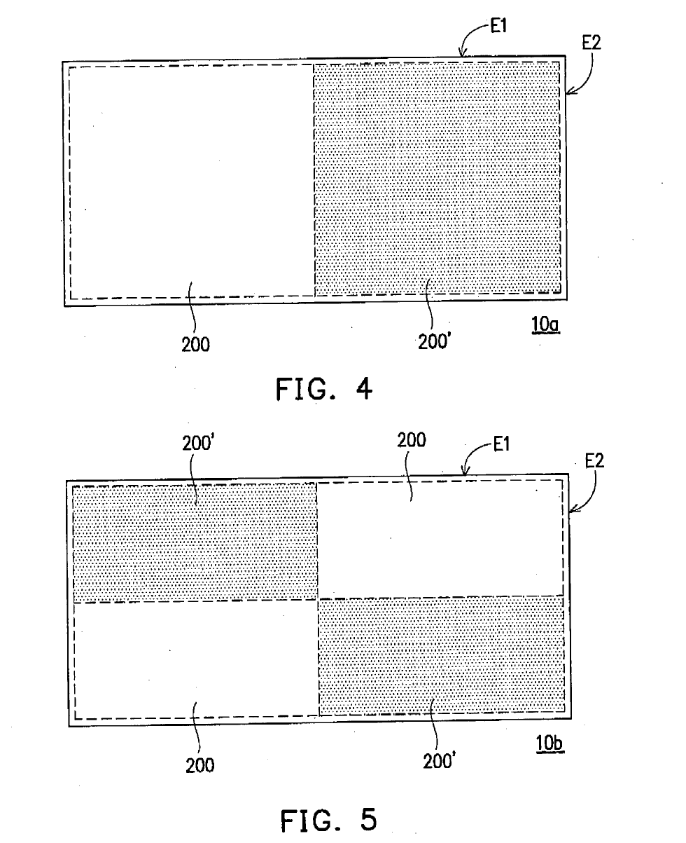

It should be noted that the light source module 200 or the light source module 200′ can be applied as the back light module in a display or the light source module for other lighting purposes. However, when the size of a back light module is bigger, a plurality of light source modules 200 and 200′ may also be disposed in the back light module, as illustrated in FIGS. 4 and 5.

FIG. 4 is a schematic bottom view of a back light module applying the light source module of the invention. FIG. 5 is a schematic bottom view of another back light module applying the light source module of the invention. Referring to FIG. 4, a back light module 10a illustrated in FIG. 4 includes a light source module 200 and a light source module 200′. The light source module 200 and the light source module 200′ may be juxtaposed along a long edge E1, and the light source module 200 and both the light source module 200′ extend along a short edge E2.

Referring to FIG. 5, a back light module 10b illustrated in FIG. 5 includes a plurality of light source modules 200 and light source modules 200′. The light source modules 200 and the light source modules 200′ may be alternately arranged along the long edge E1 and the short edge E2 of the back light module 10b. In other words, the light source modules 200 and the light source modules 200′ are alternately disposed in a matrix arrangement, as illustrated in FIG. 5.

However, the numbers and arrangements of the light source modules 200 and the light source modules 200′ only serve as examples to facilitate illustration and are not intended to limit the invention. Specifically, taking the back light module 10a illustrated in FIG. 4 as an example, the back light module 10a may include a light source module 200 and a light source module 200′; it may also include two light source modules 200 and two light source modules 200′. Hence, the light source module 200 of FIG. 4 can be randomly substituted for the light source module 200′, or the light source module 200′ for the light source module 200.

Likewise, the light source module 200 and the light source module 200′ in the back light module 10b as illustrated FIG. 5 may also be arranged and put together randomly. For example, the back light module 10b may include only four light source modules 200 or four light source modules 200′, or the back light module 10b may include three light source modules 200 (or 200′) and one light source module 200′ (or 200). Conceivably, the light source modules 200 and the light source modules 200′ in FIG. 5 may be arranged randomly, such as two light source modules 200 and two light source modules 200′ arranged along the long edge E1 (or the short edge E2).

In summary, the plurality of driving devices and the plurality of light emitting chip packages are assembled on the same circuit substrate in the light source module of the invention, so that the number of the components in the light source module is reduced and thereby lowering the manufacturing cost. Meanwhile, the light source module of the invention has the advantages of a simple assembling process and short assembling time. In addition, the metal exposed areas of the bottom surface can help the light source module dissipate heat so as to prevent the light source module from being overheated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light source module, comprising:
a circuit substrate having a top surface and a bottom surface opposite thereto, wherein the bottom surface has at least one component installed area and at least one metal exposed area;
a plurality of light emitting chip packages disposed on the top surface; and
a plurality of driving devices disposed in the component installed area, wherein the driving devices are electrically connected to the light emitting chip packages through the circuit substrate.

2. The light source module as claimed in claim 1, wherein the circuit substrate further comprises a solder mask disposed in the component installed area and exposing the metal exposed area.

3. The light source module as claimed in claim 1, wherein the metal exposed area is a copper exposed area or an aluminum exposed area.

4. The light source module as claimed in claim 1, wherein the component installed area and the metal exposed area are alternately arranged.

5. The light source module as claimed in claim 1, wherein the light emitting chip packages comprise light emitting diode (LED) packages or organic light emitting diode (OLED) packages.

6. The light source module as claimed in claim 1, further comprising a heat sink, a thermal grease or a heat pipe disposed in the metal exposed area.
